(19) United States
(12) Patent Application Publication
(10) Pub. No.: US 2025/0125860 A1
(43) Pub. Date: Apr. 17, 2025

(54) SYSTEM AND DEVICE FOR CONTROLLING COMMUNICATION WITH CLUSTERED UNMANNED AERIAL VEHICLES AND COMPUTERREADABLE STORAGE MEDIUM

(71) Applicant: ICTK Co., Ltd., Seoul (KR)

(72) Inventors: Bong Ho KANG, Seoul (KR); Hyoung Sub SHIM, Seoul (KR)

(73) Assignee: ICTK Co., Ltd., Seoul (KR)

(21) Appl. No.: 18/912,648

(22) Filed: Oct. 11, 2024

(30) Foreign Application Priority Data
Oct. 13, 2023 (KR) 10-2023-0136626

(51) Int. Cl. H04B 7/185; B64U 10/10; G05D 1/226; G05D 1/69; G05D 109/25; H04W 28/082; H04W 84/18

(52) U.S. Cl. CPC H04B 7/18504; G05D 1/226; G05D 1/69; H04W 28/082; B64U 10/10; B64U 2201/102; G05D 2109/25; H04W 84/18

(57) ABSTRACT

Provided are a system and device for controlling communication with clustered unmanned aerial vehicles (UAVs) and a storage medium on which a computer program is recorded. The system includes a server and a plurality of drone clusters configured to establish communication channels with the server and communicate with each other. Each of the plurality of drone clusters includes a master drone and slave drones configured to form a cluster with the master drone. To minimize the number of communication channels, a certain number of drone clusters are formed as the plurality of drone clusters with a master drone and a certain number of slave drones in each drone cluster.

### CROSS-REFERENCE TO RELATED APPLICATION

This application claims the benefit of priority of Korean Patent Application No. 10-2023-0136626, filed on Oct. 13, 2023, the disclosure of which is incorporated herein by reference in its entirety.

### FIELD AND BACKGROUND OF THE INVENTION

### 1. Field of the Invention

The present invention relates to a system, device, and method for controlling communication with clustered unmanned aerial vehicles (UAVs) and a storage medium on which a computer program is recorded.

### 2. Discussion of Related Art

Unmanned aerial vehicles (UAVs) are radio-controlled aircraft with no pilot on board. UAVs may be controlled by a pilot on the ground or fly automatically along a preprogrammed route, and UAVs are being used in various fields including by military and civilians, for entertainment, and the like. For convenience, UAVs will be referred to as drones here.

Drones are remotely controlled through wireless communication and were developed for military use in which drones have been used as targets for firing practice with airplanes and antiaircraft artillery. However, with the continuous development of electronic communication technology, drones are expanding their use and being utilized in various fields beyond military applications.

In particular, although “drone show” and “swarm flight” are used synonymously, a swarm flight in a drone show is not really a swarm flight because each drone has its own mission with Global Positioning System (GPS) coordinates. Rather, a swarm flight is more of a trick of getting each independently flying entity to be in a certain place at the same time.

In practice, the communication bandwidth of clustered drones sometimes exceeds a bandwidth provided by wireless communication, which leads to the practical problem of operating the cluster of a large number of drones. Accordingly, it is necessary to efficiently use communication channels to take advantage of a swarm flight. Also, it is necessary to reduce the load of communication to collaborate and cooperate on a given goal and complete a mission.

### SUMMARY OF THE INVENTION

The present invention is directed to providing a method, device, and system for controlling communication with clustered unmanned aerial vehicles (UAVs) that overcome the bandwidth limit of a communication environment by operating the UAVs while adjusting the number of groups of drone clusters or the number of drone clusters.

The present invention is also directed to providing a method, device, and system for controlling communication with clustered UAVs that allow multiple drones to accomplish a greater task than a single drone does and fly more safely and efficiently by flying together as drone clusters each including a master drone and slave drones.

The present invention is also directed to providing a method, device, and system for controlling communication with clustered UAVs that allow a plurality of drone clusters to rapidly monitor a large area, avoid an obstacle, and save fuel in cooperation with each other.

The present invention is also directed to providing a method, device, and system for controlling communication with clustered UAVs that show improved communication stability by solving the problem of communication breakdown when an error of some drones being shot down or stuck occurs.

Objects to be achieved by embodiments of the present invention are not limited thereto, and solutions described below and purposes or effects that may be found in embodiments may also be included in the objects.

According to an aspect of the present invention, there is provided a system for controlling communication with clustered UAVs, the system including a server and a plurality of drone clusters configured to establish communication channels with the server and communicate with each other.

Each of the plurality of drone clusters includes a master drone and slave drones configured to form a cluster with the master drone.

To minimize the number of communication channels, a certain number of drone clusters are formed as the plurality of drone clusters with a master drone and a certain number of slave drones in each drone cluster.

The server may include a communicator and a controller, and the controller may set a master group consisting of master drones on the basis of the number of drone clusters.

The controller may adjust the number of master drones (or mater group) to minimize a calculated number of communication channels using the number of master drones (or mater group) and the number of slave drones subordinate to one master drone.

The plurality of drone clusters may have the same number of drones.

The number of drone clusters may be the same as the number of master drones.

The number of communication channels may be set according to Equation 1 below:

$$m C 2 + sC 2 * m = number of channels \qquad [ Equation 1 ]$$

(m is the number of master drones (or mater group), and s is the number of slave drones subordinate to one master drone).

Equation 2 below may be satisfied:

$$m + s = n ( total number of drones ) . \qquad [ Equation 2 ]$$

When a master drone in a drone cluster has an error, the controller may set any one of slave drones as a new master drone.

When the new master drone is set, the controller may update the master group.

When a master drone in the master group has an error, the controller may adjust the number of master drones (or mater group) to minimize the number of communication channels.

According to another aspect of the present invention, there is provided a device for controlling communication with clustered UAVs that controls each of a plurality of drone clusters including a master drone and slave drones, the device including a memory and a processor.

The processor receives information on the total number of drones and forms a certain number of drone clusters as the plurality of drone clusters with a master drone and a certain number of slave drones in each drone cluster to minimize the number of communication channels for the plurality of drone clusters.

The processor may set a master group consisting of master drones on the basis of the number of drone clusters.

The processor may adjust the number of master drones (or mater group) to minimize a calculated number of communication channels using the number of master drones (or mater group) and the number of slave drones subordinate to one master drone.

The plurality of drone clusters may have the same number of drones.

The number of drone clusters may be the same as the number of master drones.

The number of communication channels may be set according to Equation 1 below:

$$m C 2 + sC 2 * m = number of channels \qquad [ Equation 1 ]$$

(m is the number of master drones (or mater group), and s is the number of slave drones subordinate to one master drone).

When a master drone in a drone cluster has an error, the processor may set any one of slave drones as a new master drone.

When the new master drone is set, the processor may update the master group.

When a master drone in the master group has an error, the processor may adjust the number of master drones (or mater group) to minimize the number of communication channels.

According to another aspect of the present invention, there is provided a non-transitory computer-readable storage medium on which a program including at least one instruction is recorded to perform a clustered UAV communication control method for controlling each of a plurality of drone clusters including a master drone and slave drones, the clustered UAV communication control method including receiving information on the total number of drones and forming a certain number of drone clusters as the plurality of drone clusters with a master drone and a certain number of slave drones in each drone cluster to minimize the number of communication channels.

### BRIEF DESCRIPTION OF THE SEVERAL VIEWS OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an overall view of a system for controlling communication with clustered unmanned aerial vehicles (UAVs) according to an exemplary embodiment of the present invention;

FIG. 2 is a block diagram of a device for controlling communication with clustered UAVs according to an exemplary embodiment of the present invention;

FIG. 3 is a flowchart of a device for controlling communication with clustered UAVs according to an exemplary embodiment of the present invention;

FIGS. 4 and 5 are views illustrating a process of forming a plurality of drone clusters in a system for controlling communication with clustered UAVs according to an exemplary embodiment of the present invention;

FIG. 6 is a view showing a master drone and slave drones of a drone cluster in a system for controlling communication with clustered UAVs according to an exemplary embodiment of the present invention;

FIG. 7 is a view showing a communication state of a drone cluster in a system for controlling communication with clustered UAVs according to an exemplary embodiment of the present invention; and

FIG. 8 is a view illustrating an operation of a device for controlling communication with clustered UAVs when a master drone of one drone cluster has an error.

### DESCRIPTION OF SPECIFIC EMBODIMENTS OF THE INVENTION

Since the present invention can be variously modified and have several embodiments, specific embodiments will be illustrated in the drawings and described. However, this is not intended to limit the present invention to the specific embodiments, and it is to be understood that the present invention includes all modifications, equivalents, and substitutions within the spirit and technical scope of the present invention.

Terms including ordinal numbers, such as “first,” “second,” and the like, may be used for describing various components, but the components are not limited by the terms. The terms are only used for the purpose of distinguishing one component from another. For example, a second component may be named a first component without departing from the scope of the present invention, and a first component may likewise be named a second component. The term “and/or” includes any one or a combination of a plurality of related stated items.

When a first component is referred to as being “connected” or “coupled” to a second component, the first component may be directly connected or coupled to the second component, or an intermediate component may be therebetween. On the other hand, when a first component is referred to as being “directly connected” or “directly coupled” to a second component, there is no intermediate component therebetween.

Terminology used in this specification is used only for describing specific embodiments and is not intended to limit the present invention. The singular forms include the plural forms as well unless the context clearly indicates otherwise. In this specification, the terms “comprise,” “comprising,” “include,” “including,” “have,” “having,” and the like indicate the presence of features, integers, steps, operations, components, parts, or combinations thereof stated herein and do not preclude the possibility of presence or addition of one or more other features, integers, steps, operations, components, parts, or combinations thereof.

Unless otherwise defined, all terms including technical or scientific terms used herein have the same meaning as generally understood by those of ordinary skill in the art. Terms defined in generally used dictionaries are construed as having the same meaning as would be construed in the context of the related art. Unless defined clearly in this specification, the terms are not interpreted in an ideal or excessively formal sense.

Some embodiments may be represented by functional blocks and various processing operations. All or some of the functional blocks may be implemented by various hardware and/or software elements that perform specific functions. For example, functional blocks of the present disclosure may be implemented by one or more processors or microprocessors or circuit elements for performing intended functions. Also, for example, functional blocks of the present disclosure may be implemented in various programming or scripting languages. The functional blocks may be implemented as algorithms that are executed on one or more processors. The present disclosure may employ the related art for electronic environment settings, signal processing, data processing, and/or the like. The terms “module,” “element,” and the like may be used in a broad sense and are not limited to mechanical and physical elements.

Hereinafter exemplary embodiments of the present invention will be described in detail with reference to the accompanying drawings. Throughout the drawings, like reference numerals refer to like components, and duplicate descriptions thereof will be omitted.

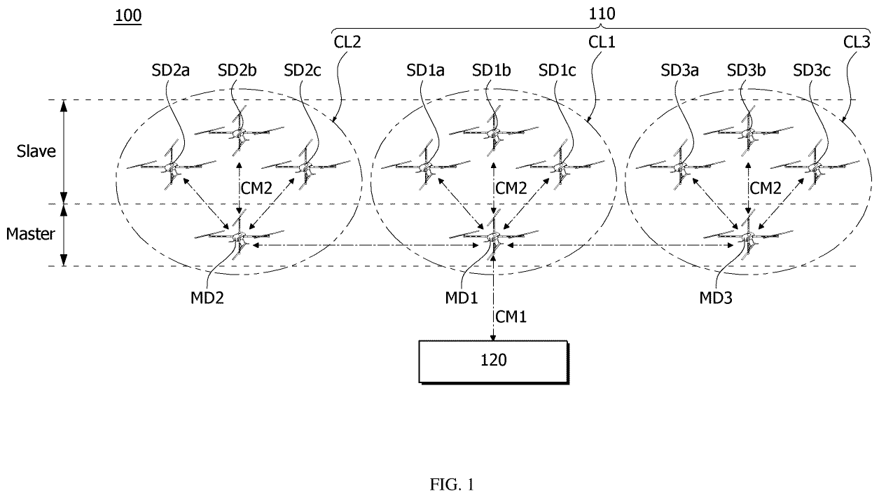

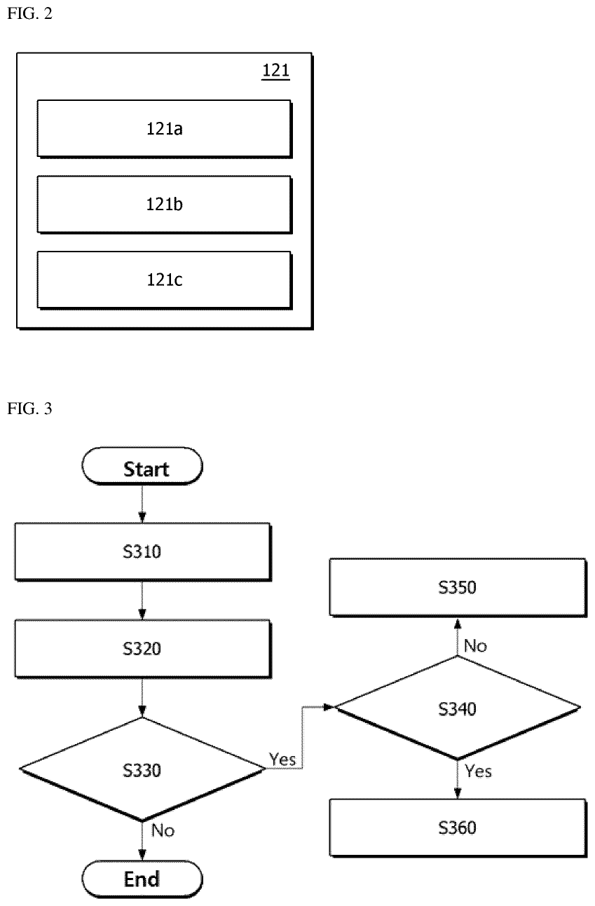

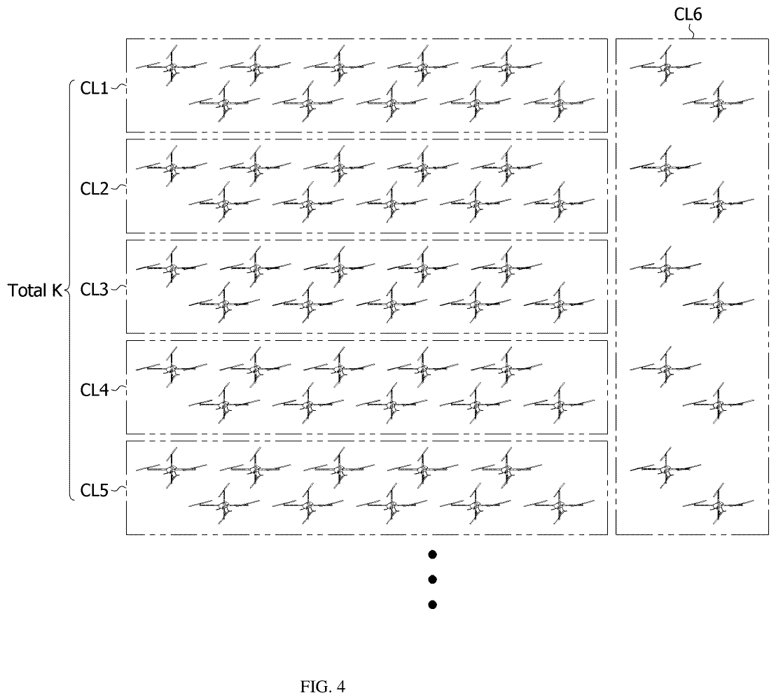

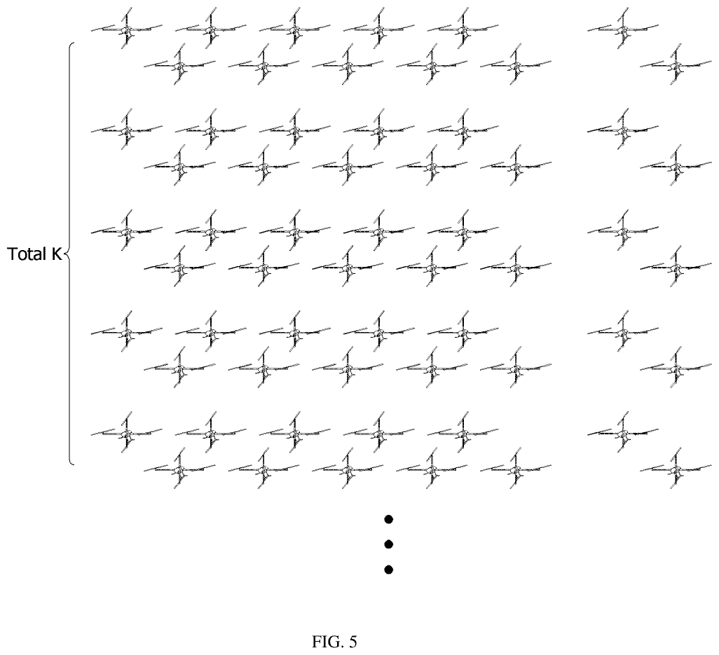

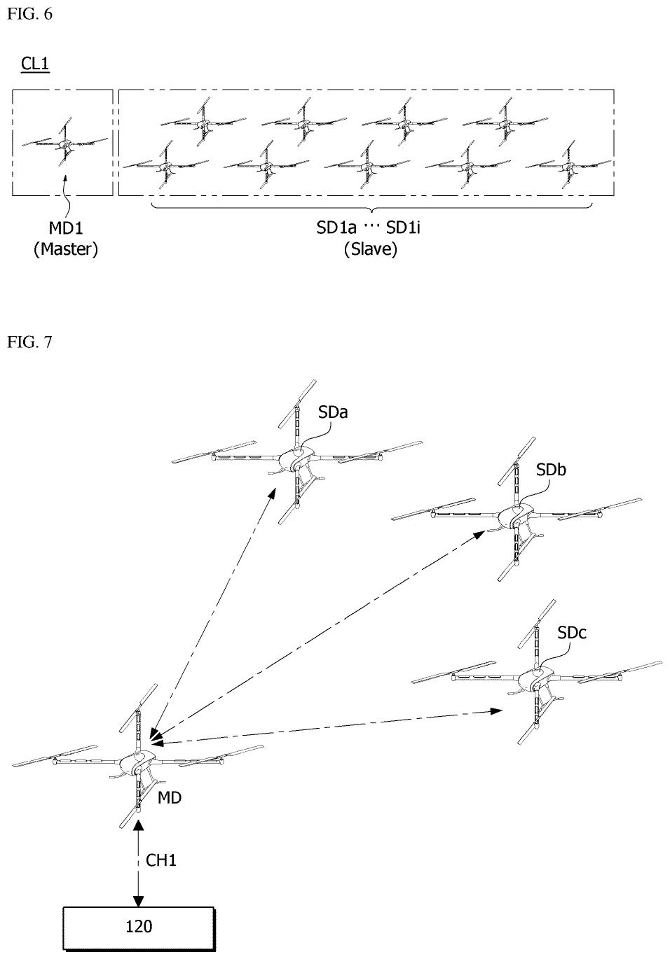

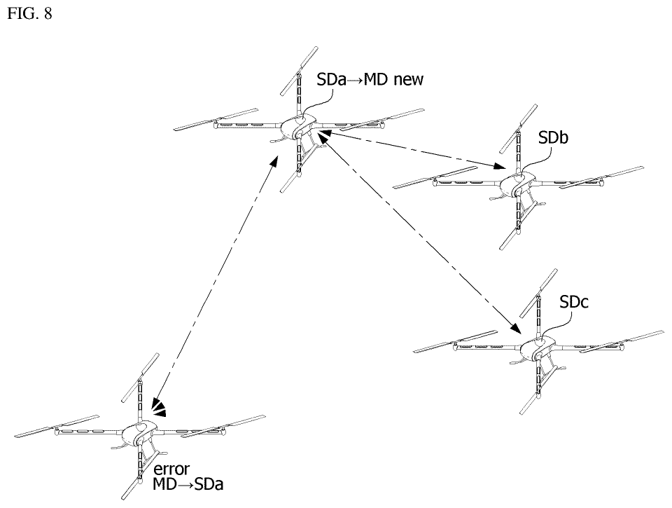

FIG. 1 is an overall view of a system for controlling communication with clustered unmanned aerial vehicles (UAVs) according to an exemplary embodiment of the present invention. FIG. 2 is a block diagram of a device for controlling communication with clustered UAVs according to an exemplary embodiment of the present invention. FIG. 3 is a flowchart of a device for controlling communication with clustered UAVs according to an exemplary embodiment of the present invention. FIGS. 4 and 5 are views illustrating a process of forming a plurality of drone clusters in a system for controlling communication with clustered UAVs according to an exemplary embodiment of the present invention. FIG. 6 is a view showing a master drone and slave drones of a drone cluster in a system for controlling communication with clustered UAVs according to an exemplary embodiment of the present invention. FIG. 7 is a view showing a communication state of a drone cluster in a system for controlling communication with clustered UAVs according to an exemplary embodiment of the present invention. FIG. 8 is a view illustrating an operation of a device for controlling communication with clustered UAVs when a master drone of one drone cluster has an error.

Referring to FIG. 1, a system 100 for controlling communication with clustered UAVs according to an exemplary embodiment of the present invention may include a plurality of UAV clusters 110 and a server 120.

The plurality of UAV clusters 110 may include a plurality of drones. In this specification, UAVs may be described as “drones,” “unmanned aircraft systems,” “unmanned airplanes,” or the like. Accordingly, the UAV clusters 110 may be drone clusters.

According to an exemplary embodiment, the server 120 may establish communication channels with a plurality of drones or the plurality of drone clusters 110 and communicate with the plurality of drones or the plurality of drone clusters 110. The server 120 may be a ground control system or a ground control server.

Also, each of the plurality of drone clusters 110 may include a master drone and slave drones. Slave drones may form a cluster with a master drone.

According to an exemplary embodiment, each of the plurality of drone clusters 110 may establish a communication channel CM1 with the server 120. Here, the server 120 may establish the communication channel CM1 with master drones MD1, MD2, and MD3 of the plurality of drone clusters 110.

In each of the plurality of drone clusters 110, a master drone and slave drones may establish a different communication channel CM2. With this configuration, it is possible to establish an optimal number of communication channels according to the total number of drones in the plurality of drone clusters 110.

The system 100 according to an exemplary embodiment may allocate or group a plurality of drones into a plurality of drone clusters. Also, the system 100 may designate a representative or master of each drone cluster among the plurality of drones so that communication can be performed between the server 120 and a cluster and within a cluster. Further, when there is a partial change in a drone cluster or communication is lost or breaks down, the system 100 according to an exemplary embodiment can firmly maintain a communication environment between the plurality of drones by setting a new master drone or master group.

The plurality of drone clusters 110 may directly or indirectly receive a manipulation signal transmitted by the server 120. The master drones MD1, MD2, and MD3 of the plurality of drone clusters 110 may provide the received manipulation signal to slave drones SD1a to SD1c, SD2a to SD2c, and SD3a to SD3c of their drone clusters. Accordingly, the plurality of drone clusters 110 can fly according to the manipulation signal received from the server 120.

The plurality of drone clusters 110 may be classified into a master group consisting of master drones and a slave group consisting of slave drones. For reference, drones may be airplane- or helicopter-shaped UAVs that may be flown or controlled by the guidance of radio waves. Further, in this specification, drones may be understood not only as the foregoing UAVs but also as sky lanterns that employ drones as their power sources.

More specifically, additionally referring to FIG. 2, the server 120 according to an exemplary embodiment may include a clustered UAV communication control device 121. Accordingly, to minimize the total number of communication channels, the server 120 may perform control so that a plurality of drone clusters including a plurality of drones are formed as the plurality of drone clusters 110 with a master drone and a certain number of slave drones in each drone cluster. In other words, the server 120 may perform optimal communication control by adjusting the number of drone clusters in consideration of the number of drones.

To this end, the server 120 or the clustered UAV communication control device 121 of the server 120 may include a communicator 121a, a memory 121b, and a controller 121c.

The communicator 121a is a device for performing wireless communication (e.g., short-range wireless communication), and the server 120 or the clustered UAV communication control device 121 of the server 120 may transmit a manipulation signal and the like to a master drone or a plurality of drone clusters using the communicator 121a. Also, the communicator 121a may receive response messages from a plurality of master drones or a plurality of drone clusters at the same time.

The memory 121b may be a device for storing at least one instruction. For example, the memory 121b may store data processed by the controller 121c and data to be processed by the controller 121c. The memory 121b may include a random access memory (RAM), such as a dynamic RAM (DRAM), a static RAM (SRAM), or the like, a read-only memory (ROM), an electrically erasable programmable ROM (EEPROM), an optical disc storage, such as a compact disc (CD)-ROM, a Blu-ray disc, or the like, a hard disk drive (HDD), a solid state drive (SSD), or a flash memory.

As described above, to minimize the total number of communication channels, the controller 121c may perform control so that a plurality of drone clusters including a plurality of drones are formed as the plurality of drone clusters 110 with a master drone and a certain number of slave drones in each drone cluster. In this way, the controller 212c may establish optimal communication channels by dividing a plurality of drones into drone clusters consisting of a certain number of drones. The controller 121c may be configured as at least one hardware unit. Also, the controller 121c may be operated by at least one software module which is generated by executing program code stored in the memory 121b. The controller 121c may execute program code stored in the memory 121b to control overall operations of the plurality of drones or the plurality of drone clusters and process data and signals. The controller 121c may be implemented as, but is not limited to, a central processing unit (CPU), a graphics processing unit (GPU), an application processor (AP), or the like provided in the server 120 or the clustered UAV communication control device 121. Also, the controller 121c may also be called a “processor” or the like.

Additionally referring to FIG. 3, the clustered UAV communication control device 121 may perform each operation of the following method of controlling communication with clustered UAVs. For example, the controller 121c or a processor may perform the method of controlling communication with clustered UAVs. It is to be understood that the following method of controlling communication with clustered UAVs may be performed by the foregoing server 120 or clustered UAV communication control device 121 through the processor or the controller.

The method of controlling communication with clustered UAVs according to an exemplary embodiment may include an operation S310 of receiving information on the total number of drones and an operation S320 of forming a plurality of drone clusters to minimize the number of communication channels for the plurality of drone clusters. Further, after the operation of forming the plurality of drone clusters, the method may include an operation S330 of receiving an error of a master drone, an operation S340 of comparing changes in the number of communication channels, and an operation S350 of setting a new master drone or an operation S360 of adjusting the number of master drones (or mater group).

Additionally referring to FIG. 4, there may be a plurality of UAVs or drones. As shown in the drawing, the number of drones may be K. For example, the number of the plurality drones may be 100.

Additionally referring to FIG. 5, the controller may control the forming of drone clusters so that the plurality of drones are allocated to the plurality of drone clusters. For example, as shown in the drawing, the server may perform cooperation or a task through a swarm flight of the 100 drones.

In this case, when the plurality of drones communicate with each other, 4,950 communication channels may be required.

For example, for communication in a drone cluster, the number of communication channels may be calculated as n(n−1)/2 on the basis of one-to-one communication. Alternatively, the number of communication channels may be calculated as nC2. Here, n is the number of components (e.g., drones) that communicate with each other.

As described above, for example, the number of communication channels for 100 drones may be 100*99/2=4,950. Assuming that each communication channel corresponds to 1 Mbps, a communication rate of 4,950 Mbps is required. In this way, communication between a plurality of drones results in an increase in the number of communication channels, which may require a considerable amount of communication resources. According to an exemplary embodiment, to overcome this resource constraint, the number of drone clusters may be adjusted for the minimization of communication channels.

For example, when 100 drones are divided or allocated to 10 drone clusters CL1, CL2, CL3, CL4, CL5, and the like, 495 communication channels may be required. In other words, when a plurality of drones are allocated to a plurality of drone clusters, the number of required communication channels may be reduced. Here, communication channels calculated by the controller include the foregoing communication channels CM1 and CM2.

Specifically, when 10 drone clusters are formed from 100 drones and internal communication (corresponding to the foregoing communication channels CM2) is performed between 10 drones in each drone cluster, it is possible to control communication with a plurality of drones using 1/10 of the communication channels from the case where no drone clusters are formed.

For example, five drone clusters may be formed. In other words, each drone cluster may consist of 20 drones including one master drone and 19 slave drones. In this case, the number of communication channels is 200, leading to the construction of a smooth communication environment. In other words, five channels may be required for communication between the server and the master drones, and 190 communication channels may be required in the drone clusters each consisting of 20 drones.

For example, when 100 drones are operated, a required communication bandwidth is 4.95 Gbps as described above. However, when drone clusters consisting of 10 drones are formed (10 master drones), a required communication bandwidth is 495 Mbps, and when drone clusters consisting of 20 drones are formed (5 master drones), a required communication bandwidth is 200 Mbps. In other words, a required communication bandwidth can be reduced. In this way, it is possible to conduct a swarm flight operation using such a small bandwidth of the exemplary embodiment. Therefore, the system 100 for controlling communication with clustered UAVs according to the exemplary embodiment of the present invention can establish communication channels for a plurality of drones within a relieved bandwidth limit.

According to an exemplary embodiment, in each drone cluster, a master drone may communicate with the server and relay or distribute a message or signal received from the server to slave drones subordinate to the master drone. In this way, a necessary operation can be conducted in an improved communication environment.

According to an exemplary embodiment, the controller may calculate the number of channels according to Equations 1 and 2 below.

$$m C 2 + sC 2 * m = number of channels \qquad [ Equation 1 ]$$

(m is the number of master drones (or mater group), and s is the number of slave drones subordinate to one master drone).

s may vary depending on the master. For example, when there are three masters, the number of slave drones may be s1, s2, and s3 according to the masters. s1, s2, and s3 may be different or the same.

$$m + s = n ( total number of drones ) \qquad [ Equation 2 ]$$

Here, the controller may set the number of drone clusters by considering the number of drones to minimize the number of channels. This may be similarly applied not only to one-to-one communication but also to multichannel communication. The number of communication channels may increase in proportion to the number of multiple channels. In other words, when Equations 1 and 2 are satisfied, the minimum number of channels (or communication channels) may be likewise established for multichannel communication.

Considering the above-described example, the controller may form five drone clusters, which require fewer communication channels than 10 drone clusters, rather than 10 drone clusters from 100 drones.

Also, the controller may set a master group consisting of master drones on the basis of the number of drone clusters. In other words, according to an exemplary embodiment, the number of drone clusters may be the same as the number of master drones. Accordingly, a system, method, and device for controlling clustered UAVs according to exemplary embodiments facilitate clustering.

In other words, as shown in FIG. 6, one master drone MD1 may be present in one drone cluster CL1. The case where 10 drone clusters are formed from 100 drones will be described. In each drone cluster, drones other than a master drone MD1 may be slave drones SD1a to SD1i.

Also, the plurality of drone clusters may have the same number of drones. In this way, it is possible to easily form the plurality of drone clusters and easily distribute the bandwidths of communication channels.

Referring to FIGS. 7 and 8, in the system according to an exemplary embodiment, when a drone (ex, master dorn) has an error in a drone cluster, the controller may set any one of slave drones as a new master drone. When a slave drone has an error, the number of master drones (or mater group) or the number of drone clusters may be maintained even after the number of master drones (or mater group) or the number of drone clusters is adjusted to minimize the number of channels. In this way, when the number of master drones (or mater group) or the number of drone clusters is maintained, the number of drone clusters may not be adjusted. In other words, the controller can maintain the same master drones (or mater group) as they are before the error.

Also, when a master drone has an error in a drone cluster, the controller may set any one of slave drones as a new master drone.

For example, when a master drone which is the leader of one drone cluster is shot down, the controller may cause another slave drone or a lower-ranked slave drone to assume the role of the master (or leader) drone.

As shown in FIG. 8, when an error, such as being shot down or the like, occurs with an existing master drone, any one SDa of a plurality of slave drones may be set as a new master drone MDnew. Also, when the new master drone MDnew is set, the controller may update a master group.

In other words, the controller may set a new master drone, and the new master drone may transmit a current state or a manipulation state to another master drone or the server. Accordingly, it is possible to facilitate the progression and control of overall operations.

Further, when an error or the like occurs with an existing master drone MD, the existing master drone MD may be changed to a slave drone SCa by the controller. Subsequently, the server may communicate with the new master drone MDnew.

In other words, a plurality of slave drones may take over the position of a master in a preset or stored sequence, and thus it is possible to easily handle the absence of a group leader or master which is the mainstay of communication. Accordingly, communication channels smoothly operate, and collaborative operations can be continuously maintained.

For example, according to an exemplary embodiment, when the communication channel between a master drone and the server is terminated, communication in the cluster can be maintained by setting any one of slave drones that form the cluster with the master drone (or mater group) as a new master drone of the cluster and the drone.

Further, when an existing master drone can operate as a slave drone, the existing master drone may be changed to a slave drone of a new master drone. Accordingly, in the corresponding cluster, the existing master drone may operate as a slave drone in communication with the new master drone.

In addition, it may be difficult for an existing master drone to operate as a slave drone. In this case, the number of master drones (or mater group) and the number of drones in a cluster may be adjusted in consideration of the number of channels. Specifically, when a master drone in a master group has an error, the controller may adjust the number of master drones (or mater group) to minimize the number of channels. For example, unless the number of master drones (or mater group) is maintained or the number of channels is one less or more than the existing number, the number of master drones (or mater group) may be adjusted. In other words, the number of drone clusters may be adjusted.

Even when it is difficult for an existing master drone to operate as a slave drone, the number of master drones (or mater group) may be maintained if the number of clusters is the same. Also, only in the cluster of a master drone having difficulty operating, the number of master drones (or mater group) and slave drones may change. Accordingly, it is possible to efficiently control communication channels for UAVs.

The clustered UAV communication control device in the server may include an electronic device. In this specification, a display device may also be an electronic device. The electronic device may include at least one of a smartphone, a tablet, a personal computer (PC), a mobile phone, a videophone, an e-book reader, a desktop PC, a laptop PC, a netbook computer, a workstation, a server, a personal digital assistant (PDA), a media box, a game console, an electronic dictionary, and a wearable device. The wearable device may include at least one of an accessory type device (e.g., a watch, a ring, a wristband, an anklet, a necklace, glasses, contact lenses, or a head-mounted device (HMD)), a fabric- or clothing-type device (e.g., electronic clothing), a body-attachable device (e.g., a skin pad or tattoo), and a bio-implantable circuit. In various embodiments, the electronic device is not limited to the foregoing devices and may be a combination of two or more thereof.

The method, device, and system for controlling communication with clustered UAVs according to the disclosed embodiments may be implemented in the form of program instructions that are executable by various computing means, and recorded on a computer-readable recording medium. Also, an embodiment of the present disclosure may be a computer-readable recording medium on which one or more programs including instructions for implementing the method, device, and system for controlling communication with clustered UAVs are recorded.

The computer-readable recording medium may include program instructions, data files, data structures, and the like solely or in combination. The program instructions recorded on the medium may be those specially designed and constructed for the present invention or well known and available to those skilled in the computer software field. Examples of the computer-readable recording medium include magnetic media such as an HDD, a floppy disk, and magnetic tape, optical media such as a CD-ROM and a digital versatile disc (DVD), magneto-optical media such as a floptical disk, and hardware devices specially configured to store and execute the program instructions such as a ROM, a RAM, a flash memory, and the like. Examples of the program instructions include not only machine code produced by a compiler but also high-level language code that is executable by a computer using an interpreter or the like.

A machine-readable storage medium may be provided in the form of a non-transitory storage medium. Here, the term “non-transitory” means that the storage medium does not include a signal (e.g., electromagnetic waves) and is tangible, but does not distinguish whether data is permanently or temporarily stored in the storage medium. For example, a “non-transitory storage medium” may include a buffer in which data is temporarily stored.

The method, device, and system for controlling communication with clustered UAVs according to the various embodiments disclosed herein may be provided in a computer program product. The computer program product may be traded between a seller and a purchaser as a commodity. The computer program product may be distributed in the form of a machine-readable storage medium (e.g., a CD-ROM) or distributed online (e.g., downloaded or uploaded) directly between two user devices (e.g., smartphones) through an application store (e.g., PlayStore™). In the case of online distribution, at least a portion of the computer program product may be stored at least temporarily or temporarily in a storage medium such as a memory of a manufacturer's server, an application store's server, or a relay server.

Specifically, the method, device, and system for controlling communication with clustered UAVs according to the disclosed embodiments may be provided as a computer program product including a recording medium on which a program for implementing the method, device and system is recorded.

Although exemplary embodiments have been described in detail above, the scope of the present invention is not limited thereto, and various modifications and alterations made by those skilled in the art from the spirit of the present invention defined in the following claims also fall within the scope of the present invention.

As used herein, the term “unit” refers to a software or hardware component, such as a field-programmable gate array (FPGA) or application-specific integrated circuit (ASIC), which performs certain roles. However, the term “unit” is not meant to be limited to software or hardware. A “unit” may be included in an addressable storage medium or configured to operate one or more processors. Therefore, according to an embodiment, a “unit” includes components, such as software components, object-oriented software components, class components, and task components, processes, functions, attributes, procedures, subroutines, segments of program code, drivers, firmware, microcode, circuitry, data, databases, data structures, tables, arrays, and variables. Functionality provided in components and “units” may be combined into fewer components and “units” or may be further subdivided into additional components and “units.” In addition, components and “units” may be implemented to operate one or more CPUs in a device or a secure multimedia card.

According to embodiments, it is possible to implement a method, device, and system for controlling communication with clustered UAVs that overcome the bandwidth limit of a communication environment by operating the UAVs while adjusting the number of groups of drone clusters or the number of drone clusters.

According to embodiments, it is also possible to implement a method, device, and system for controlling communication with clustered UAVs that allow multiple drones to accomplish a greater task than a single drone does and fly more safely and efficiently by flying together as drone clusters each including a master drone and slave drones.

According to embodiments, it is also possible to implement a method, device, and system for controlling communication with clustered UAVs that allow a plurality of drone clusters to rapidly monitor a large area, carry a large number of things, avoid an obstacle, and save fuel in cooperation with each other.

According to embodiments, it is also possible to implement a method, device, and system for controlling communication with clustered UAVs that show improved communication stability by solving the problem of communication breakdown when an error of some drones being shot down or stuck occurs.

According to embodiments, it is also possible to implement a method, device, and system for controlling communication with clustered UAVs that overcome the limit of a given bandwidth and achieve a goal of mission accomplishment through cooperation, which is the object of a swarm flight, when the number of communication channels for a plurality of drones increases to, for example, n(n−1)/2.

Various advantages and effects of the present invention are not limited to those described above and may be easily understood from the above process of describing specific embodiments of the present invention.

Although exemplary embodiments of the present invention have been mainly described, these are merely illustrative and do not limit the present invention, and those of ordinary skill in the art should know that various modifications and applications not illustrated above can be made without departing from the essential characteristics of the exemplary embodiments. For example, each component specified in an embodiment can be implemented in a modified form. In addition, differences of the modifications and applications are construed as falling within the scope of the present invention defined in the following claims.

What is claimed is:

1. A system for controlling communication with clustered unmanned aerial vehicles (UAVs), the system comprising:
a server; and
a plurality of drone clusters configured to establish communication channels with the server and communicate with each other,
wherein each of the plurality of drone clusters includes:
a master drone; and
slave drones configured to form a cluster with the master drone, and
to minimize a number of communication channels, a certain number of drone clusters are formed as the plurality of drone clusters with a master drone and a certain number of slave drones in each drone cluster.

2. The system of claim 1, wherein the server comprises:
a communicator; and
a controller,
wherein the controller sets a master group consisting of master drones on the basis of the number of drone clusters.

3. The system of claim 2, wherein the controller adjusts the number of master drones to minimize a calculated number of communication channels using the number of master drones and the number of slave drones subordinate to one master drone.

4. The system of claim 1, wherein the plurality of drone clusters have the same number of drones.

5. The system of claim 2, wherein the number of drone clusters is the same as the number of master drones.

6. The system of claim 2, wherein the number of communication channels is set according to Equation 1 below:
$$m C 2 + sC 2 * m = number of channels \qquad [ Equation 1 ]$$
(m is the number of master drones, and s is the number of slave drones subordinate to one master drone).

7. The system of claim 6, wherein Equation 2 below is satisfied:
$$m + s = n ( total number of drones ) . \qquad [ Equation 2 ]$$

8. The system of claim 2, wherein, when a master drone in a drone cluster has an error, the controller sets any one of slave drones as a new master drone.

9. The system of claim 8, wherein, when the new master drone is set, the controller updates the master group.

10. The system of claim 2, wherein, when a master drone in a master group has an error, the controller adjusts the number of master drones to minimize the number of communication channels.

11. A device for controlling communication with clustered unmanned aerial vehicles (UAVs) that controls each of a plurality of drone clusters including a master drone and slave drones, the device comprising:
a memory; and
a processor,
wherein the processor receives information on a total number of drones and forms a certain number of drone clusters as the plurality of drone clusters with a master drone and a certain number of slave drones in each drone cluster to minimize a number of communication channels for the plurality of drone clusters.

12. The device of claim 11, wherein the processor sets a master group consisting of master drones on the basis of the number of drone clusters.

13. The device of claim 12, wherein the processor adjusts the number of master drones to minimize a calculated number of communication channels using the number of master drones and the number of slave drones subordinate to one master drone.

14. The device of claim 11, wherein the plurality of drone clusters have the same number of drones.

15. The device of claim 12, wherein the number of drone clusters is the same as the number of master drones.

16. The device of claim 15, wherein the number of communication channels is set according to Equation 1 below:
$$m C 2 + sC 2 * m = number of channels \qquad [ Equation 1 ]$$
(m is the number of master drones, and s is the number of slave drones subordinate to one master drone).

17. The device of claim 12, wherein, when a master drone in a drone cluster has an error, the processor sets any one of slave drones as a new master drone.

18. The device of claim 17, wherein, when the new master drone is set, the processor updates the master group.

19. The device of claim 12, wherein, when a master drone in the master group has an error, the processor adjusts the number of master drones to minimize the number of communication channels.

20. A non-transitory computer-readable storage medium on which a program including at least one instruction is recorded to perform a clustered unmanned aerial vehicle (UAV) communication control method for controlling each of a plurality of drone clusters including a master drone and slave drones, wherein the clustered UAV communication control method comprises:
receiving information on a total number of drones; and
forming a certain number of drone clusters as the plurality of drone clusters with a master drone and a certain number of slave drones in each drone cluster to minimize a number of communication channels.
